(19) United States
(12) Patent Application Publication
(10) Pub. No.: US 2026/0211256 A1
(43) Pub. Date: Jul. 23, 2026

(54) OPTICAL SYSTEM AND DISPLAY DEVICE

(71) Applicant: SONY GROUP CORPORATION, Tokyo (JP)

(72) Inventor: Toshifumi YASUI, Kanagawa (JP)

(73) Assignee: SONY GROUP CORPORATION, Tokyo (JP)

(21) Appl. No.: 19/157,864

(22) PCT Filed: Feb. 13, 2024
(86) PCT No.: PCT/JP2024/004728

§ 371 Date: Aug. 19, 2025

(30) Foreign Application Priority Data
Mar. 7, 2023 (JP) 2023-034638

(51) Int. Cl. G02B 27/42; G02B 27/00; G02B 27/28; G06F 1/16

(52) U.S. Cl. CPC G02B 27/4211; G02B 27/0037; G02B 27/288; G06F 1/163

(57) ABSTRACT

An optical system is an optical system that forms an image of light from a display panel on a retina when combined with an eyeball, the optical system including: a first refractive lens that collects light from the display panel; and a first diffractive lens provided between the first refractive lens and an image forming position, in which the first diffractive lens is configured such that a phase of light passing through an outer peripheral portion of the first diffractive lens is delayed from a phase of light passing through a central portion of the first diffractive lens.

### FIELD

The present disclosure relates to an optical system and a display device.

### BACKGROUND

In a display device such as a head mounted display (HMD) device, it is known that a triple-pass optical system is used in which an optical path is folded back twice by two reflecting surfaces (for example, see Patent Literature 1).

### CITATION LIST

### Patent Literature

Patent Literature 1: WO 2021/106048 A

### SUMMARY

### Technical Problem

In the display device and the optical system thereof as described above, there remains room for consideration of achieving a wide angle of view. Some lenses are already included in the optical system, and it is not easy to achieve a wide angle of view by further adding a refractive lens while maintaining a sufficient edge thickness.

One aspect of the present disclosure enables achieving a wide angle of view.

### Solution to Problem

An optical system according to one aspect of the present disclosure is an optical system that forms an image of light from a display panel on a retina when combined with an eyeball, the optical system includes: a first refractive lens that collects the light from the display panel; and a first diffractive lens provided between the first refractive lens and the eyeball, wherein the first diffractive lens is configured such that a phase of light passing through an outer peripheral portion of the first diffractive lens is delayed from a phase of light passing through a central portion of the first diffractive lens.

A display device according to one aspect of the present disclosure includes: a display panel; and an optical system that forms an image of light from the display panel on a retina when combined with an eyeball, wherein the optical system includes: a first refractive lens that collects the light from the display panel; and a first diffractive lens provided between the first refractive lens and the eyeball, and the first diffractive lens is configured such that a phase of light passing through an outer peripheral portion of the first diffractive lens is delayed from a phase of light passing through a central portion of the first diffractive lens.

### BRIEF DESCRIPTION OF DRAWINGS

FIG. 1 is a diagram illustrating an example of a schematic configuration of a display device 1 according to a first embodiment.

FIG. 2 is a diagram illustrating an example of a schematic configuration of an optical system 3.

FIG. 3 is a diagram illustrating an example of a schematic configuration of a diffractive lens 8-1.

FIG. 4 is a diagram illustrating an example of an amount of optical phase delay.

FIG. 5 is a diagram illustrating a design example.

FIG. 6 is a diagram illustrating the design example.

FIG. 7 is a diagram illustrating the design example.

FIG. 8 is a diagram illustrating the design example.

FIG. 9 is a diagram illustrating the design example.

FIG. 10 is a diagram illustrating the design example.

FIG. 11 is a diagram illustrating the design example.

FIG. 12 is a diagram illustrating an example of a schematic configuration of the display device 1 according to a second embodiment.

FIG. 13 is a diagram illustrating an example of the schematic configuration of the optical system 3.

FIG. 14 is a diagram illustrating an example of a schematic configuration of a diffractive lens 8-2.

FIG. 15 is a diagram illustrating an example of an amount of phase delay.

FIG. 16 is a diagram illustrating a design example.

FIG. 17 is a diagram illustrating the design example.

FIG. 18 is a diagram illustrating the design example.

FIG. 19 is a diagram illustrating the design example.

FIG. 20 is a diagram illustrating the design example.

FIG. 21 is a diagram illustrating the design example.

FIG. 22 is a diagram illustrating another design example.

FIG. 23 is a diagram illustrating the other design example.

FIG. 24 is a diagram illustrating the other design example.

FIG. 25 is a diagram illustrating the other design example.

FIG. 26 is a diagram illustrating the other design example.

FIG. 27 is a diagram illustrating the other design example.

FIG. 28 is a diagram illustrating the other design example.

FIG. 29 is a diagram illustrating a modification.

FIG. 30 is a diagram illustrating the modification.

FIG. 31 is a diagram illustrating a modification.

FIG. 32 is a diagram illustrating the modification.

### DESCRIPTION OF EMBODIMENTS

Hereinafter, embodiments of the present disclosure will be described in detail with reference to the drawings. Note that, in the following embodiments, the same elements are denoted by the same reference numerals, and redundant description may be omitted. The same reference numerals may be used for different meanings between different embodiments, and in that case, may be interpreted according to the description in the embodiment.

The present disclosure will be described in accordance with the following order of items.
0. Introduction
1. First Embodiment
2. Second Embodiment
3. Modifications
4. Examples of effects

### 0. Introduction

A display device such as an HMD includes an optical system for forming an image of light from a display panel on a retina and displaying a video when combined with an eyeball. It is not rare that the optical system already includes many lenses, and it is not easy to further add a refractive lens while maintaining a sufficient edge thickness to achieve a wide angle of view. In addition, handling of a lateral chromatic aberration can also be a problem.

For example, a method is conceivable of suppressing the lateral chromatic aberration by incorporating a meniscus lens into an optical system. However, in that case, a distance from a pupil position to a reflecting surface in the optical system increases, an effective diameter increases, and this further leads to a decrease in the edge thickness, so that it is difficult to achieve a wide angle of view.

In addition, a method is conceivable of achieving a wide angle of view by giving strong power using one holographic optical element (HOE) or the like. However, in that case, if one HOE system is thinned, a coma aberration occurs, and it is difficult to obtain sufficient resolving power. Although it is possible to suppress the coma aberration by making the HOE thicker, it is necessary to use highly coherent light such as a laser because the HOE system has strong wavelength selectivity. This is expensive and leads to an increase in weight.

At least some of the above problems are handled by disclosed technologies. Although details will be described later, a diffractive lens is incorporated in a triple-pass optical system including a refractive lens, whereby a wide angle of view is achieved. For example, by bending light passing through an outer peripheral portion of the diffractive lens in the optical axis direction, it is possible to prevent the light from spreading too much and the lens from being large.

Two diffractive lenses may be provided, and light beams passing through the outer peripheral portions of respective diffractive lenses may be given phase delays having signs opposite to each other. It can also be said that the diffractive lens that gives a positive phase delay has a divergent phase at the outer peripheral portion thereof, and the diffractive lens that gives a negative phase delay has a convergent phase at the outer peripheral portion thereof. The latter diffractive lens brings a direction of light passing through the outer peripheral portion thereof close to the optical axis direction, so that it is possible to suppress the lens from being large due to excessive spread of light. In addition, the lateral chromatic aberration generated in one diffractive lens can be canceled by the other diffractive lens. Furthermore, field curvature and astigmatism can be reduced by a balance between the two. A high aberration correction effect and a wide angle of view are achieved.

Since the edge thickness is more easily secured than in the case of using the meniscus lens, a viewing angle (field of view (FOV)) can be widened. In addition, since more refractive lenses can be included in the optical system than in the case of using one HOE system described above, the coma aberration can be reduced accordingly, and high resolving power can be obtained. Note that a method is also conceivable of using one diffractive lens instead of the original refractive lens, but adding a diffractive lens has an advantage that correction terms of field curvature and astigmatism can be added. A higher resolution and the like can be achieved.

### 1. First Embodiment

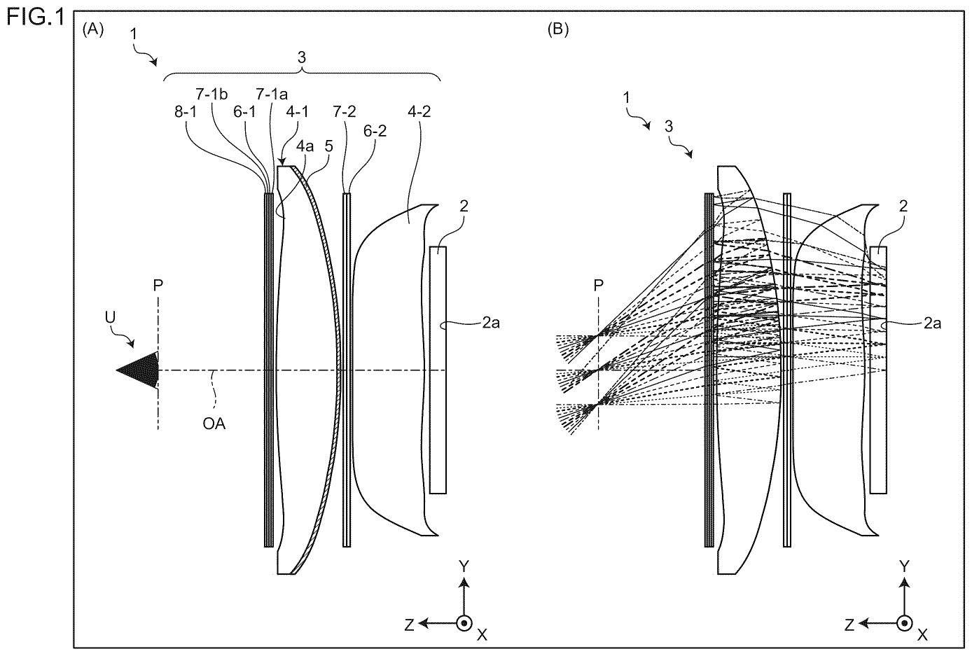

FIG. 1 is a diagram illustrating an example of a schematic configuration of a display device 1 according to a first embodiment. The display device 1 is, for example, an HMD device that displays a video for virtual reality (VR), and in (A) of FIG. 1, an eye portion (pupil) of a user U wearing and using the display device 1 is schematically illustrated. The eye portion (for example, a pupil) of the user U is located at a position where light from one point of the display device 1 is substantially parallel light or in the vicinity thereof, whereby the video is observed by the user U. A position (plane) where light is substantially parallel light is referred to as a pupil position P (pupil plane) and illustrated. Note that the video may be interpreted as a meaning of the image and read as appropriate within a range without contradiction.

An XYZ coordinate system is also illustrated. The display device 1 and the user U are located in this order in the Z-axis positive direction. Unless otherwise specified, it is assumed that each of elements of the display device 1 extends in the XY plane direction and has a thickness in the Z-axis direction. In (A) of FIG. 1, a side surface (which may be a cross section) of the display device 1 as viewed in the X-axis direction is schematically illustrated. In (B) of FIG. 1, paths of several light beams (also referred to as rays of light, a light flux, or the like) are schematically illustrated.

The display device 1 includes a display panel 2 and an optical system 3. The display panel 2 and the optical system 3 are disposed in this order in the Z-axis positive direction. Note that, in (A) of FIG. 1, an optical axis OA of the optical system 3 is illustrated by a one-dot chain line.

The display panel 2 includes, for example, an organic light emitting diode (OLED), a liquid crystal (LC), a light emitting diode (LED), and the like. The display surface of the display panel 2 is referred to as a display surface 2a and illustrated.

When combined with the eyeball, the optical system 3 forms an image of light from the display panel 2 on the retina. The optical system 3 includes a refractive lens 4, a semitransparent mirror 5, a polarizing plate 6, a QWP 7 (¼ wavelength plate), and a diffractive lens 8. There may be a plurality of at least some of these elements, and in this example, there are a plurality of the refractive lenses 4, a plurality of the polarizing plates 6, and a plurality of the QWPs 7.

A first refractive lens among the plurality of refractive lenses 4 is referred to as a refractive lens 4-1 and illustrated. A second refractive lens is referred to as a refractive lens 4-2 and illustrated. In a case where they are not particularly distinguished from each other, they are simply referred to as the refractive lens 4.

A first polarizing plate among the plurality of polarizing plates 6 is referred to as a polarizing plate 6-1 and illustrated. A second polarizing plate is referred to as a polarizing plate 6-2 and illustrated. In a case where they are not particularly distinguished from each other, they are simply referred to as the polarizing plate 6.

A first QWP among the plurality of QWPs 7 is referred to as a QWP 7-1. A second QWP is referred to as a QWP 7-2 and illustrated. In a case where they are not particularly distinguished from each other, they are simply referred to as the QWP 7. In addition, the QWP 7-1 is a pair of QWPs, and the QWPs are respectively referred to as a QWP 7-1a and a QWP 7-1b and illustrated. In a case where they are not particularly distinguished from each other, they are simply referred to as the QWP 7-1.

The diffractive lens 8 is one diffractive lens 8 in this example, but for convenience of description, the diffractive lens 8 is referred to as a diffractive lens 8-1 (first diffractive lens) and illustrated.

In the example illustrated in (A) of FIG. 1, the refractive lens 4-2, the polarizing plate 6-2, the QWP 7-2, the semitransparent mirror 5, the refractive lens 4-1, the QWP 7-1a, the polarizing plate 6-1, the QWP 7-1b, and the diffractive lens 8-1 are disposed in this order in the Z-axis positive direction. The light from the display panel 2 passes through those elements and becomes substantially parallel light at the pupil position P. Note that, in the following description, light traveling in the optical system 3 along the Z-axis positive direction may be simply referred to as the light from the display panel 2.

The refractive lens 4-2 is provided between the display panel 2 and the polarizing plate 6-2. The light from the display panel 2 passes through the refractive lens 4-2 and is incident on the polarizing plate 6-2.

The polarizing plate 6-2, the QWP 7-2, the semitransparent mirror 5, the refractive lens 4-1, the QWP 7-1a, the polarizing plate 6-1, and the QWP 7-1b constitute a so-called triple-pass optical system. For example, it is possible to contribute to making the optical system 3 thinner and smaller. Although details will be described later, the optical system 3 is configured such that the light from the display panel 2 passes through the refractive lens 4-1 three times by folding back the optical path. Finally, circularly polarized light is emitted from the QWP 7-1b toward the diffractive lens 8-1.

Among the constituent elements of the triple-pass optical system described above, the refractive lens 4-1 and the semitransparent mirror 5 will be described here first. The refractive lens 4-1 collects the light from the display panel 2. The refractive lens 4-1 is provided between the display panel 2 and the pupil position P, more specifically, between the semitransparent mirror 5 and the QWP 7-1a in this example, and makes the light from the display panel 2 substantially parallel light at the pupil position P.

A surface on the pupil position P side (Eyeball side, Z-axis positive direction side) in the refractive lens 4-1 is referred to as a surface 4a and illustrated. In one embodiment, the surface 4a of the refractive lens 4-1 may have an inflection point. As a result, aberration balance can be maintained. For example, when a second-order differential value of an amount of sag on the surface 4a side with respect to a distance from the optical axis OA on the surface 4a of the refractive lens 4-1 is graphed, a sign of the second-order differential value is reversed at a certain distance as a boundary. A specific example will be described later.

The semitransparent mirror 5 is provided between the display panel 2 and the refractive lens 4-1, more specifically, between the QWP 7-2 and the refractive lens 4-1 in this example. The semitransparent mirror 5 allows a part (for example, about 50%) of the incident light to pass therethrough and reflects the rest. The semitransparent mirror 5 may be a semitransparent mirror film provided on a surface of the refractive lens 4-1 on the display panel 2 side (Z-axis negative direction side).

The diffractive lens 8-1 is provided between the refractive lens 4-1 and the pupil position P, more specifically, between the QWP 7-1b and the pupil position P in this example. The circularly polarized light from the QWP 7-1b becomes substantially parallel light at the pupil position P after passing through the diffractive lens 8-1. In one embodiment, the diffractive lens 8-1 may be a polarization diffractive lens. As a result, it is easy to cope with oblique incidence and wavelength variation. Hereinafter, a description will be given assuming that the diffractive lens 8-1 is a polarization diffractive lens.

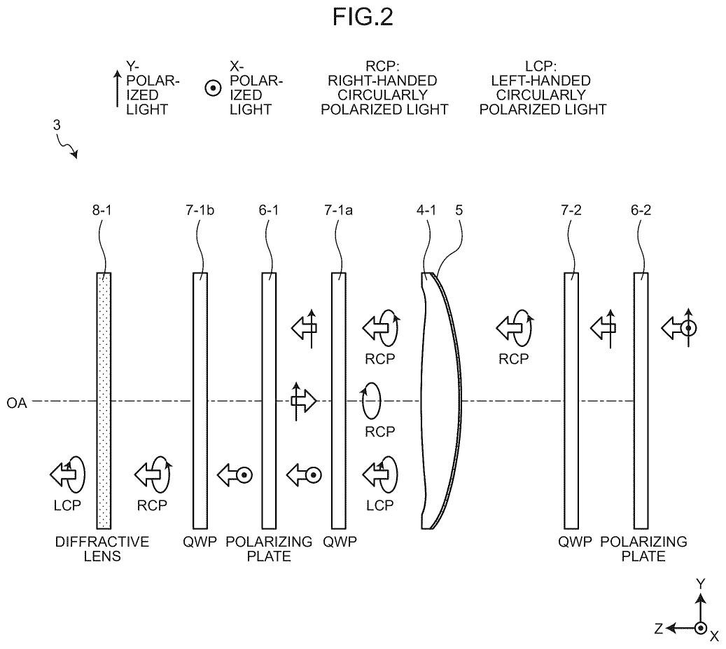

The optical system 3 will be further described with reference to FIG. 2.

FIG. 2 is a diagram illustrating an example of a schematic configuration of the optical system 3. Note that, in FIG. 2, elements are drawn to be disposed at intervals, but in practice, the elements may be disposed at intervals shorter than the illustrated intervals, and further, may be disposed adjacent to or superimposed on each other.

In FIG. 2, a direction of light is schematically illustrated by a white arrow at some places in the optical system 3. The light beams can include various types of polarized light (polarized components). Examples of the polarized light include linearly polarized light and circularly polarized light. A polarization direction is schematically illustrated by a black arrow. Of the linearly polarized light, polarized light polarized in the X-axis direction is referred to as X-polarized light. Polarized light polarized in the Y-axis direction is referred to as Y-polarized light. The circularly polarized light is right-handed circularly polarized light or left-handed circularly polarized light, and is referred to as RCP or LCP and illustrated.

The polarizing plate 6-2 allows only specific polarized light to pass therethrough and reflects other polarized light. The polarizing plate 6-2 is, for example, a polarizer, a wire grid polarizer, or the like. In this example, the polarizing plate 6-2 allows Y-polarized light to pass therethrough.

By providing the polarizing plate 6-2, it is possible to limit polarized light incident on the QWP 7-2 after the polarizing plate 6-2. For example, it is effective in a case where the display panel 2 emits light including various types of polarized light, such as an OLED. In a case where the display panel 2 emits only light including specific polarized light, such as an LCD, the polarizing plate 6-2 may not be provided.

The QWP 7-2 converts linearly polarized light from the polarizing plate 6-2 into circularly polarized light. In this example, the QWP 7-2 converts the Y-polarized light from the polarizing plate 6-2 into right-handed circularly polarized light. A part of the right-handed circularly polarized light passes through the semitransparent mirror 5, further passes through the refractive lens 4-1, and is incident on the QWP 7-1a.

The QWP 7-1a converts the right-handed circularly polarized light having passed through the refractive lens 4-1 into Y-polarized light. In this example, the polarizing plate 6-1 allows X-polarized light to pass therethrough and reflects Y-polarized light. Thus, the Y-polarized light from the QWP 7-1a is reflected by the polarizing plate 6-1 and is incident on the QWP 7-1a again. The QWP 7-1a converts the Y-polarized light from the polarizing plate 6-1 into right-handed circularly polarized light. The right-handed circularly polarized light passes through the refractive lens 4-1, and a part thereof is reflected by the semitransparent mirror 5. The reflected light becomes left-handed circularly polarized light, passes through the refractive lens 4-1, and is incident on the QWP 7-1a. The QWP 7-1a converts the left-handed circularly polarized light having passed through the refractive lens 4-1 into X-polarized light. The X-polarized light passes through the polarizing plate 6-1 and is incident on the QWP 7-1b. In this manner, the light passes through the refractive lens 4-1 three times by folding back the optical path.

The QWP 7-1b converts the X-polarized light from the polarizing plate 6-1 into right-handed circularly polarized light. The right-handed circularly polarized light is incident on the diffractive lens 8-1.

As described above, the diffractive lens 8-1 here is a polarization diffractive lens, and is configured such that an order of diffraction is inverted according to the polarization direction of the incident circularly polarized light, and has a lens function. In addition, the polarization direction (rotation direction) of the circularly polarized light emitted from the diffractive lens 8-1 is opposite to the polarization direction of the circularly polarized light incident on the diffractive lens 8-1. In this example, since the right-handed circularly polarized light from the QWP 7-1b is incident on the diffractive lens 8-1, the circularly polarized light emitted from the diffractive lens 8-1 becomes left-handed circularly polarized light.

The diffractive lens 8-1 is also referred to as a polarization-directed flat lens, a Pancharatnam-Berry Phase lens, a Geometrci Phase lens, or the like. Various known configurations may be adopted. Briefly describing some examples, for example, the diffractive lens 8-1 may have a configuration in which a photo-alignment film and a liquid crystal layer are sequentially provided on a base material (one-layer planar configuration). The photo-alignment film is exposed by polarization interference, and the liquid crystal layer is aligned along the photo-alignment film. On the liquid crystal layer, a photo-alignment film and a liquid crystal layer may be further disposed (two-layer planar configuration). In addition, various known configurations may be adopted, such as a two-layer twisted configuration.

The diffractive lens 8-1 may have a thickness smaller than the thickness of the refractive lens 4. For example, as compared with the case of using a refractive lens similar to the refractive lens 4, it is easier to incorporate the lens into the optical system 3. It is possible to contribute to making the optical system 3 thinner and smaller.

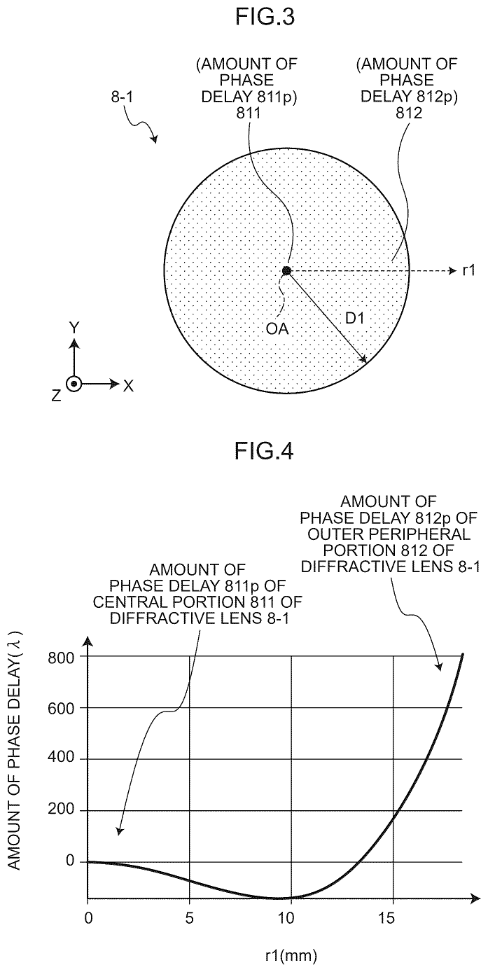

In the present embodiment, the diffractive lens 8-1 is configured to have a divergent phase at the outermost periphery thereof. A description will be given also with reference to FIGS. 3 and 4.

FIG. 3 is a diagram illustrating an example of a schematic configuration of the diffractive lens 8-1. The diffractive lens 8-1 as viewed from the front (as viewed in the Z-axis direction) is schematically illustrated. In this example, the diffractive lens 8-1 has a circular shape whose center is located on the optical axis OA. The radius of the diffractive lens 8-1 is referred to as a radius D1. The distance from the center of the diffractive lens 8-1 is referred to as a distance r1. Unless otherwise specified, it is assumed that the diffractive lens 8-1 has a symmetrical shape with respect to the center. In this case, the distance r1 may be a distance x from the center in the X-axis direction or a distance y from the center in the Y-axis direction.

The diffractive lens 8-1 includes a central portion 811 and an outer peripheral portion 812. The central portion 811 is a portion including the center of the diffractive lens 8-1. The outer peripheral portion 812 is a portion including the outermost periphery of the diffractive lens 8-1 (also referred to as an edge portion including the edge). When described using the distance r, the central portion 811 is a portion corresponding to a range of a relatively small distance r1 (including r1=0). The outer peripheral portion 812 is a portion corresponding to a range of a relatively large distance r1 (including r1=D1).

The diffractive lens 8-1 has the divergent phase at the outer peripheral portion 812. Specifically, the diffractive lens 8-1 is configured such that a phase of light passing through the outer peripheral portion 812 is delayed from a phase of light passing through the central portion 811. For example, the diffractive lens 8-1 gives a positive phase delay to the light passing through the outer peripheral portion 812, and gives a positive phase delay smaller than that of the light passing through the outer peripheral portion 812 or a negative phase delay to the light passing through the central portion 811.

The amount of phase delay of the light passing through the central portion 811 of the diffractive lens 8-1 is referred to as an amount of phase delay 811p. The amount of phase delay of the light passing through the outer peripheral portion 812 of the diffractive lens 8-1 is referred to as an amount of phase delay 812p.

FIG. 4 is a diagram illustrating an example of the amount of phase delay. The horizontal axis of the graph indicates the distance r1. The vertical axis of the graph indicates the amount of phase delay. The amount of phase delay is indicated by a value normalized by a wavelength λ of the light. As an overall tendency, the amount of phase delay increases in the positive direction as the distance r1 increases. The amount of phase delay 812p of the light passing through the outer peripheral portion 812 is a positive value. The amount of phase delay 811p of the light passing through the central portion 811 is a positive value smaller than the amount of phase delay 812p or a negative value. When the amount of phase delay is a positive value, incident light is subjected to diverging action. On the other hand, when the amount of phase delay is a negative value, incident light is subjected to converging action.

As illustrated in FIGS. 1 and 2 described above, the diffractive lens 8-1 having the divergent phase at the outermost periphery is provided between the refractive lens 4-1 and the pupil position P, and right-handed polarized light from the diffractive lens 8-1 becomes substantially parallel light at the pupil position P.

According to the configuration described above, since the optical system 3 includes not only the refractive lens 4-1 but also the diffractive lens 8-1, the lens function can be improved accordingly. As the lens function is improved, a possibility of achieving a wide angle of view is increased.

### Design Example

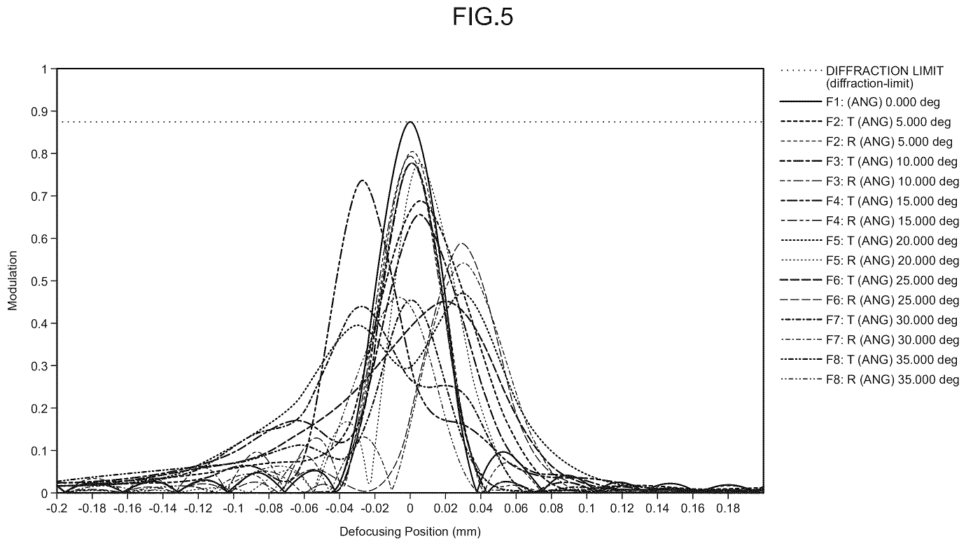

FIGS. 5 to 11 are diagrams illustrating a design example. The size of one pixel of the display device 1 is assumed to be 6.3 m.

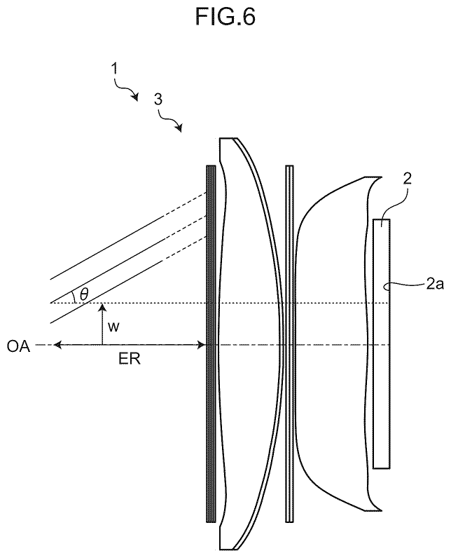

FIG. 5 illustrates examples of a modulation transfer function (MTF) (MTF corresponding to one pixel) at 80 lines/mm. On the basis of a dimension when eyeball rotation is considered, the resolving power for each incidence, more specifically, the resolving power in the tangential direction (T) and the radial direction (R) for each angle is indicated. Here, the wavelength of light is assumed to be 554 nm. Specifically, as illustrated in FIG. 6, assuming that an eyeball rotation angle is θ and an eye relief is ER, a value at a position away (shifted) from the optical axis OA by w=ER×tan θ is indicated. As indicated in the graph of FIG. 5, it can be seen that high resolving power is obtained. For example, a center resolving power of about 48 pixels per degree (PPD) is obtained.

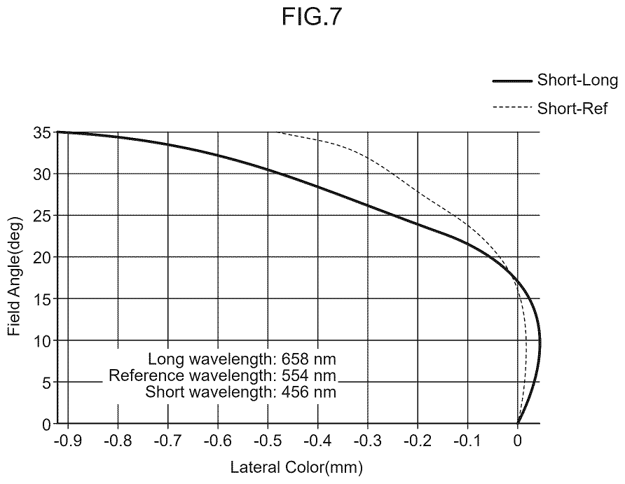

FIG. 7 illustrates an example of the lateral chromatic aberration at the time of eyeball rotation. The vertical axis of the graph represents an angle (Field Angle) when the optical system 3 is viewed. The horizontal axis of the graph indicates a distance (difference) between positions of two light beams having different wavelengths on the display panel 2 (for example, on the display surface 2a). A graph line Short-Long indicates a difference between a position of light having a wavelength of 456 nm and a position of light having a wavelength of 658 nm on the display panel 2. A graph line Short-Ref indicates a difference between a position of light having a wavelength of 456 nm and a position of light having a wavelength of 554 nm on the display panel 2. When the angle is small, the lateral chromatic aberration is very small, and has a good value less than or equal to one pixel. When the angle is large, the lateral chromatic aberration increases, but if the angle is a certain value, the lateral chromatic aberration can be handled by signal processing or the like. It can be seen that a practical lateral chromatic aberration is obtained.

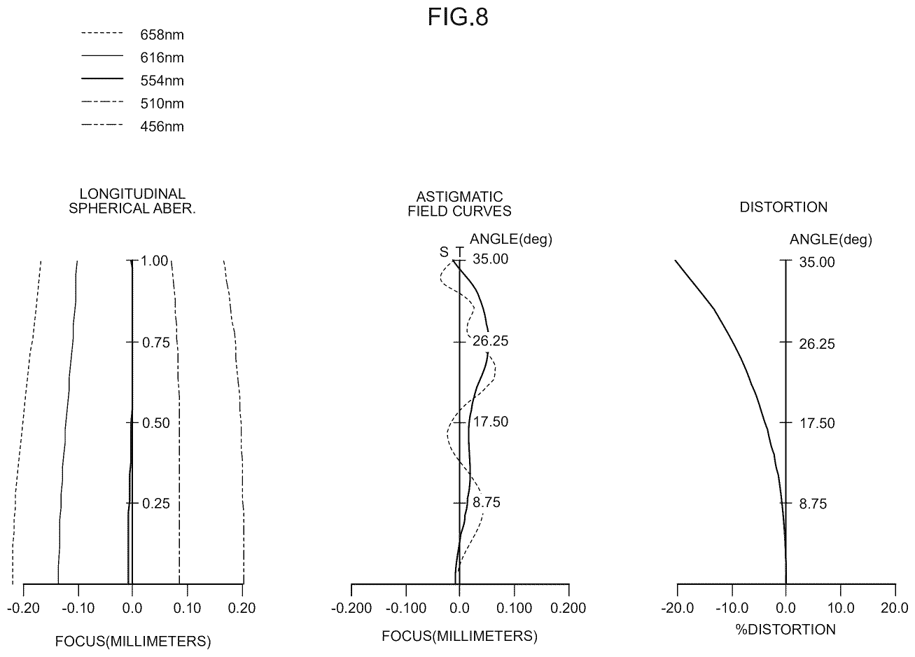

FIG. 8 illustrates examples of longitudinal aberration, astigmatism, and distortion. The longitudinal aberration is at most just over 0.2, and the variation is small. The astigmatism is within ±0.1. The distortion is inclined to the negative side and monotonically changes (there is no inflection point).

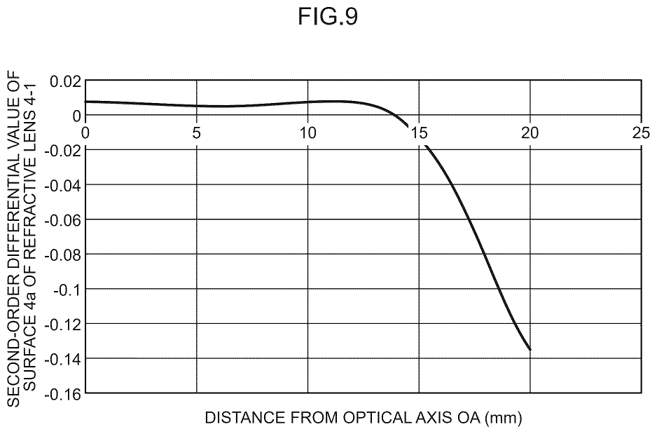

FIG. 9 illustrates an example of the inflection point of the surface 4a of the refractive lens 4-1. The horizontal axis of the graph indicates a distance from the optical axis on the surface 4a of the refractive lens 4-1. The vertical axis of the graph indicates a second-order differential value of the surface 4a of the refractive lens 4-1, more specifically, the second-order differential value of the amount of sag on the surface 4a side with respect to the distance from the optical axis OA. The sign of the second-order differential value is reversed at a certain value (a value slightly before 15 mm in this example) of the distance from the optical axis OA as a boundary. The shape of the surface 4a of the refractive lens 4-1 having an inflection point is defined on the basis of such a second-order differential value, for example. As described above, the surface 4a of the refractive lens 4-1 has an inflection point, whereby aberration balance can be maintained.

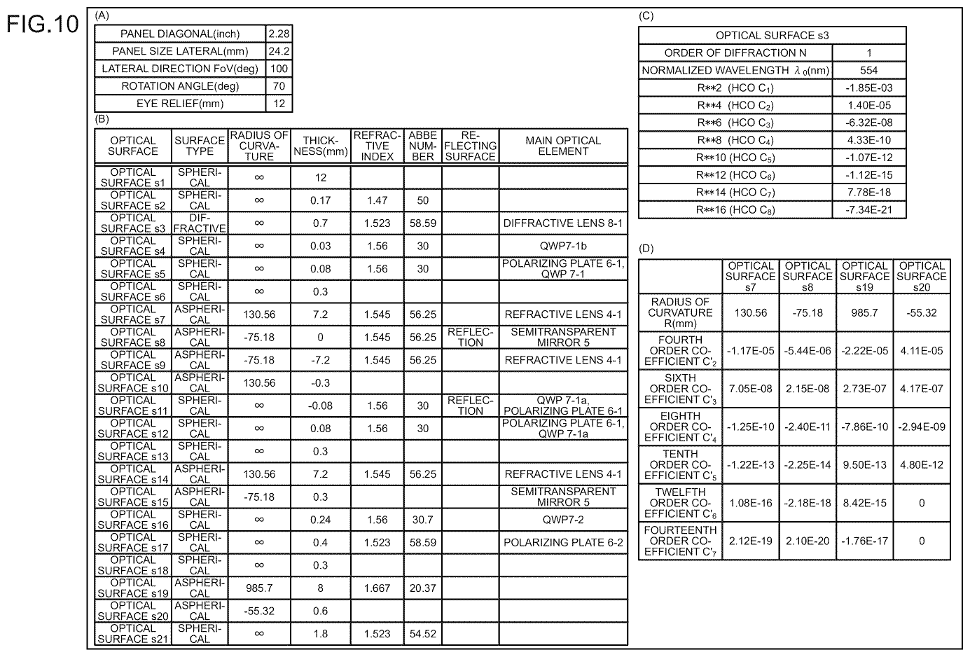

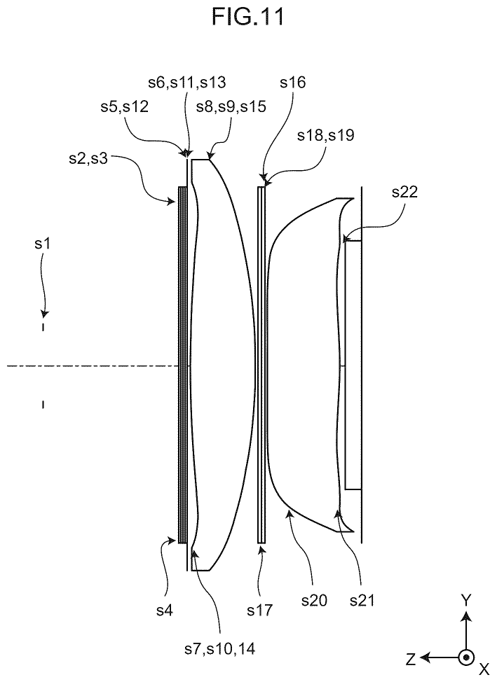

FIGS. 10 and 11 illustrate examples of data on some optical surfaces. FIG. 10 illustrates examples of data on an optical surface s1 to an optical surface s21. Specific locations of respective optical surfaces are as illustrated in FIG. 11. Note that the optical surface s1 is an optical surface at the pupil position P (for example, a pupil of the user U).

As indicated in (A) of FIG. 10, in this example, the diagonal length (panel diagonal) of the display panel 2 is 2.28 inches. The length (panel size lateral) of the panel of the display panel 2 in the lateral direction (for example, the X-axis direction) is 24.2 mm. The viewing angle in the lateral direction (lateral direction FoV) is 100°. The rotation angle is 70°. The eye relief is 12 mm.

In (B) of FIG. 10, indicated are a surface type, a radius of curvature, a thickness, a refractive index, an Abbe number, and a reflecting surface of each of the optical surface s1 to the optical surface s21. In addition, some main elements of optical elements described so far are also indicated in association. The surface type is either spherical, diffractive, or aspherical. The radius of curvature in a case where the surface type is aspherical is a paraxial radius of curvature. The thickness here indicates a distance from the optical surface to the next optical surface. The thickness with a positive value corresponds to a length in the Z-axis negative direction, and the thickness with a negative value corresponds to a length in the Z-axis positive direction. The refractive index is a refractive index at the d-line. The Abbe number is the Abbe number of a difference between the C line and the F line with the d line as a reference. In the case of the reflecting surface, it is described as reflection.

In (C) of FIG. 10, indicated are further data on the optical surface s3. The optical surface s3 corresponds to the surface of the diffractive lens 8-1 described above, and gives a phase delay to light passing therethrough. When the amount of phase delay is denoted by φ, φ is expressed by Formula (1) below. N is the order of diffraction, λ₀ is the normalized wavelength, and h is the height (distance) from the axis OA. Numerical examples of cₙ (n=1 to 8) in Formula (1) are indicated in (C) of FIG. 10.

$$Amount of phase delay ϕ = N \frac{{\sum }_{n = 1}^{8} {C}_{n} {h}^{2 n}}{{λ}_{0}} \qquad ( 1 )$$

In (D) of FIG. 10, indicated are further data on the optical surfaces whose surface type is aspherical. Specifically, indicated are coefficients that define amounts of aspherical sag of the optical surface s7, the optical surface s8, the optical surface s9, and the optical surface s20. The amount of aspherical sag is expressed by Formula (2) below. R is the radius of curvature, and h is the height from the optical axis OA. Numerical examples of C′ₙ (n=2 to 7) in Formula (2) are indicated in (D) of FIG. 10.

$$Amount of aspherical sag = \frac{\frac{1}{R} {h}^{2}}{1 + \sqrt{1 - \frac{{h}^{2}}{{R}^{2}}}} + {\sum }_{x = 2}^{7} {C}_{n}^{′} {h}^{2 n} \qquad ( 2 )$$

In other optical surfaces whose surface type is aspherical, the amounts of aspherical sag of the optical surface s10 and the optical surface s14 are similar to that of the optical surface s7. The amounts of aspherical sag of the optical surface s9 and the optical surface s15 are similar to that of the optical surface s8.

Note that the total system focal length of the optical system 3 obtained by this design example is about 17.1 mm.

### 2. Second Embodiment

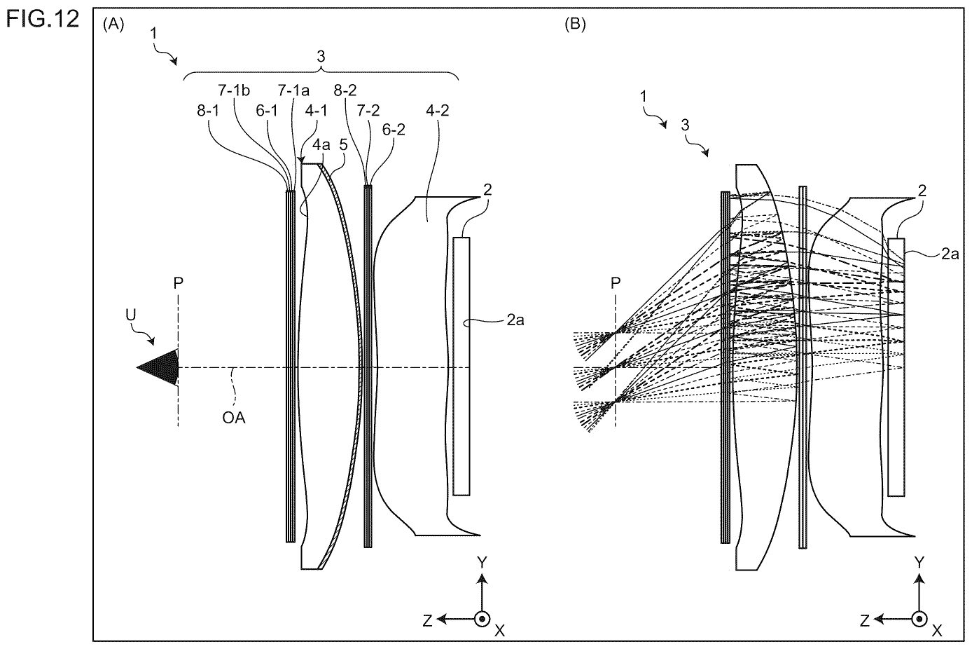

FIG. 12 is a diagram illustrating an example of a schematic configuration of the display device 1 according to a second embodiment. As indicated in (A) of FIG. 12, the display device 1 further includes a diffractive lens 8-2. The diffractive lens 8-2 is a second diffractive lens provided separately from the diffractive lens 8-1. Similarly to the diffractive lens 8-1, the diffractive lens 8-2 may have a thickness smaller than the thickness of the refractive lens 4, and may be a polarization diffractive lens. Hereinafter, both the diffractive lens 8-1 and the diffractive lens 8-2 are assumed to be polarization diffractive lenses. Note that, in (B) of FIG. 12, several light paths are schematically illustrated.

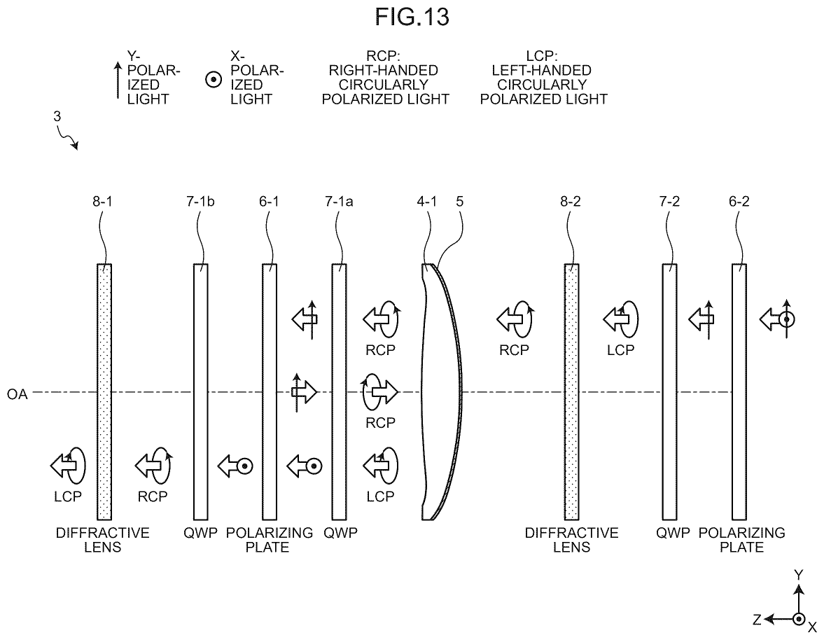

FIG. 13 is a diagram illustrating an example of the schematic configuration of the optical system 3. In this example, the QWP 7-2 converts the Y-polarized light from the polarizing plate 6-2 into left-handed polarized light. The left-handed polarized light is incident on the diffractive lens 8-2.

The diffractive lens 8-2 is provided between the display panel 2 and the refractive lens 4-1, more specifically, between the QWP 7-2 and the semitransparent mirror 5 in this example. Since the left-handed circularly polarized light from the QWP 7-2 is incident on the diffractive lens 8-2, circularly polarized light emitted from the diffractive lens 8-2 becomes right-handed circularly polarized light. A part of the right-handed circularly polarized light passes through the semitransparent mirror 5. Subsequent operation is similar to that of FIG. 2 described above, and thus the description thereof will not be repeated here.

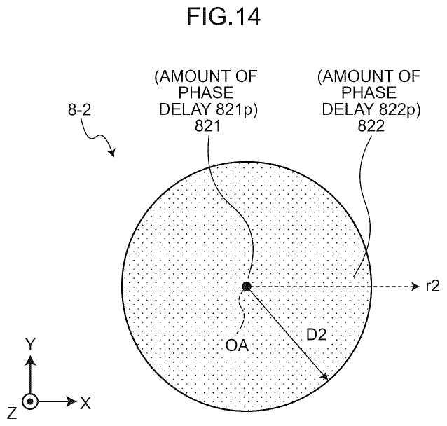

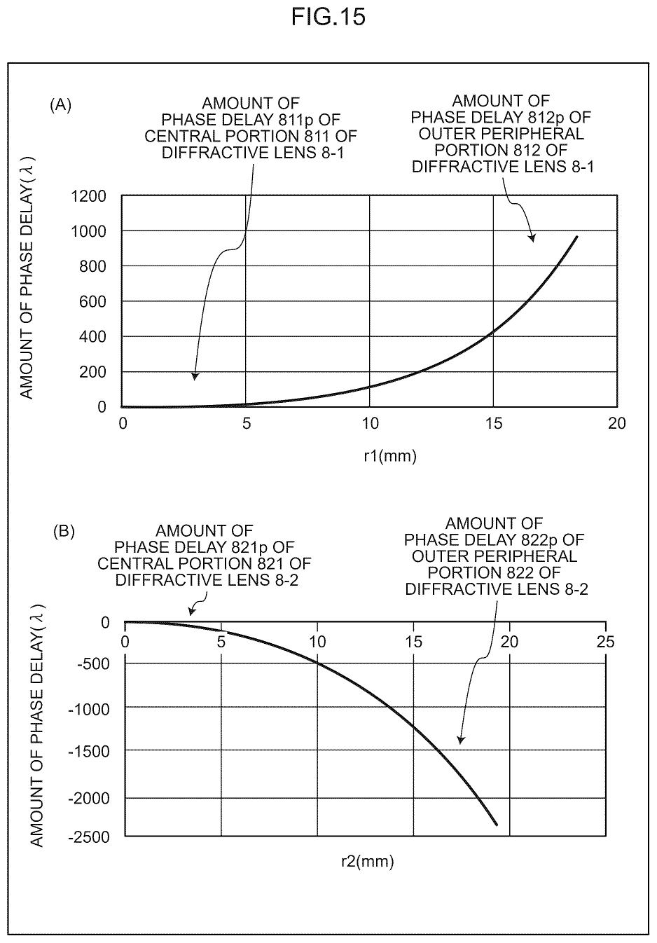

As described above, the diffractive lens 8-1 is configured to have the divergent phase at the outermost periphery thereof. On the other hand, the diffractive lens 8-2 is configured to have a convergent phase at the outermost periphery thereof. A description will be given also with reference to FIGS. 14 and 15.

FIG. 14 is a diagram illustrating an example of a schematic configuration of the diffractive lens 8-2. The diffractive lens 8-2 as viewed from the front view (as viewed in the Z-axis direction) is schematically illustrated. In this example, the diffractive lens 8-2 has a circular shape whose center is located on the optical axis OA. The radius of the diffractive lens 8-2 is referred to as a radius D2. The distance from the center of the diffractive lens 8-2 is referred to as a distance r2. Unless otherwise specified, it is assumed that the diffractive lens 8-2 has a symmetrical shape with respect to the center. In this case, the distance r2 may be the distance x from the center in the X-axis direction or the distance y from the center in the Y-axis direction.

The diffractive lens 8-2 includes a central portion 821 and an outer peripheral portion 822. The central portion 821 is a portion including the center of the diffractive lens 8-2. The outer peripheral portion 822 is a portion including the outermost periphery of the diffractive lens 8-2 (also referred to as an edge portion including the edge). When described using the distance r2, the central portion 821 is a portion corresponding to a range of a relatively small distance r2 (including r2=0). The outer peripheral portion 822 is a portion corresponding to a range of a relatively large distance r2 (including r2=D2).

The diffractive lens 8-2 has the convergent phase at the outer peripheral portion 822. Specifically, the diffractive lens 8-2 is configured such that a phase of light passing through the outer peripheral portion 822 advances more than a phase of light passing through the central portion 821. For example, the diffractive lens 8-2 gives a negative phase delay (positive phase advance) to the light passing through the outer peripheral portion 822, and gives a negative phase delay having an absolute value smaller than that of the light passing through the outer peripheral portion 822 or a positive phase delay to the light passing through the central portion 821.

The amount of phase delay of the light passing through the central portion 821 of the diffractive lens 8-2 is referred to as an amount of phase delay 821p. The amount of phase delay of the light passing through the outer peripheral portion 822 of the diffractive lens 8-2 is referred to as an amount of phase delay 822p.

FIG. 15 is a diagram illustrating an example of the amount of phase delay. In (A) of FIG. 15, the amount of phase delay given by the diffractive lens 8-1 is illustrated. As the distance r1 increases, the amount of phase delay increases in the positive direction. The amount of phase delay 812p of the light passing through the outer peripheral portion 812 is a positive value. The amount of phase delay 811p of the light passing through the central portion 811 is a positive value smaller than the amount of phase delay 812p or zero. In (B) of FIG. 15, the amount of phase delay given by the diffractive lens 8-2 is illustrated. As the distance r2 increases, the amount of phase delay increases in the negative direction. The amount of phase delay 822p of the light passing through the outer peripheral portion 822 is a negative value. The amount of phase delay 821p of the light passing through the central portion 821 is a negative value having an absolute value smaller than that of the amount of phase delay 822p or zero.

As illustrated in FIGS. 12 and 13 described above, the diffractive lens 8-1 having the divergent phase at the outermost periphery is provided between the refractive lens 4-1 and the pupil position P, and the diffractive lens 8-2 having the convergent phase at the outermost periphery is provided between the display panel 2 and the refractive lens 4-1. The diffractive lens 8-2 brings a direction of the light passing through the outer peripheral portion 822 close to a direction of the optical axis OA (optical axis direction). As a result, it is possible to prevent the light from spreading too much and the lens from being large. A possibility of achieving a wider angle of view is increased. In addition, the lateral chromatic aberration generated in one diffractive lens of the diffractive lens 8-1 and the diffractive lens 8-2 can be canceled by the other diffractive lens, and the lateral chromatic aberration can be suppressed. Furthermore, field curvature and astigmatism can be reduced by a balance between the two. A high aberration correction effect and a wide angle of view are achieved.

The refractive lens 4-2 will be further described. The refractive lens 4-2 is provided between the display panel 2 and the diffractive lens 8-2, more specifically, between the refractive lens 4-2 and the polarizing plate 6-2 in this example, and gives positive power to light passing through the outermost periphery (also referred to as an outer peripheral portion) thereof. In other words, the refractive lens 4-2 is configured to bring the light from the display panel 2 close to the direction of the optical axis OA (optical axis direction). As a result, it becomes possible to maintain aberration balance. It is also possible to maintain a balance between field curvature and distortion.

### Design Example

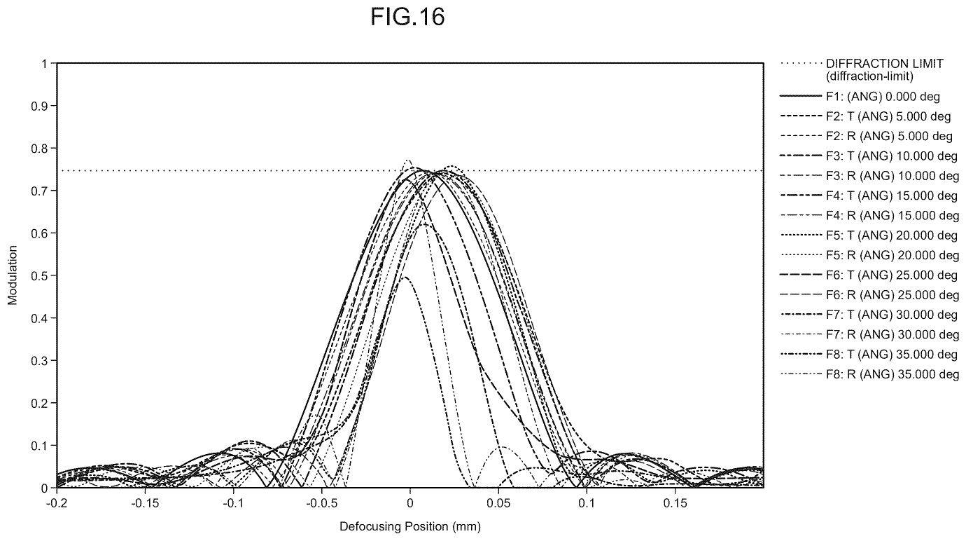

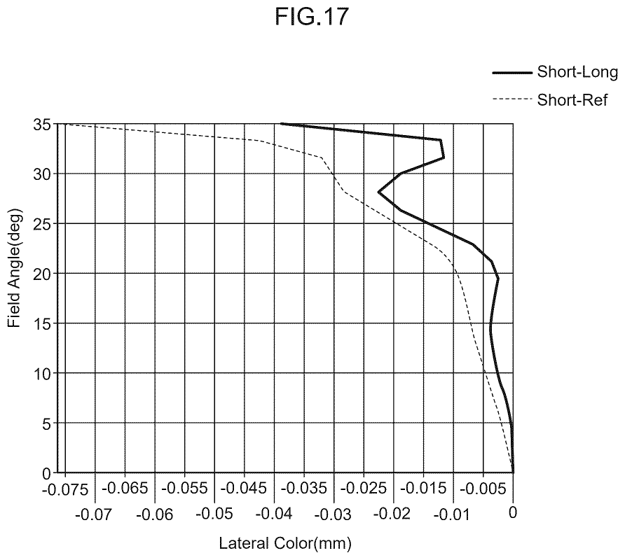

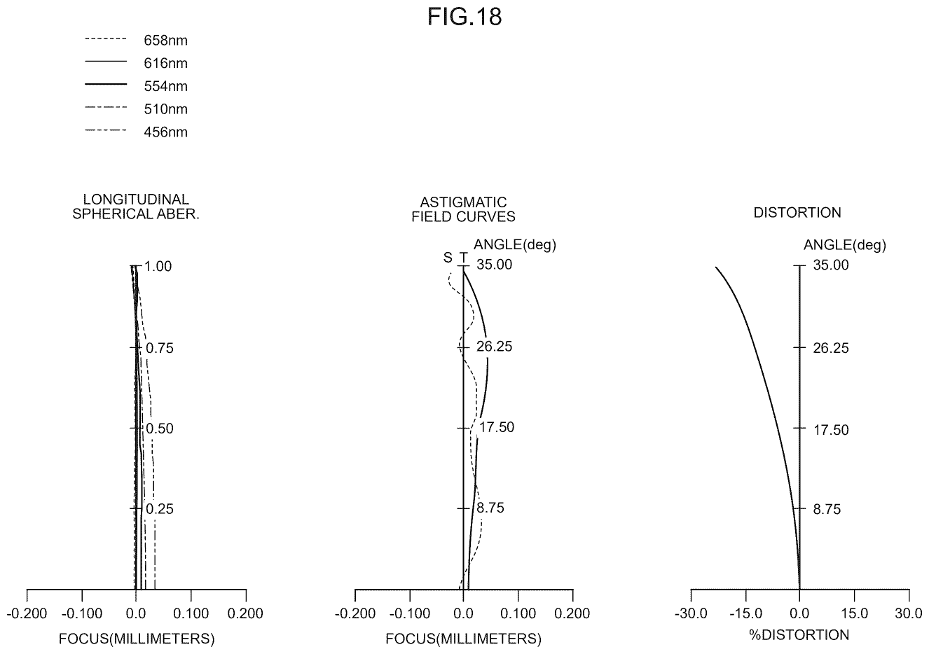

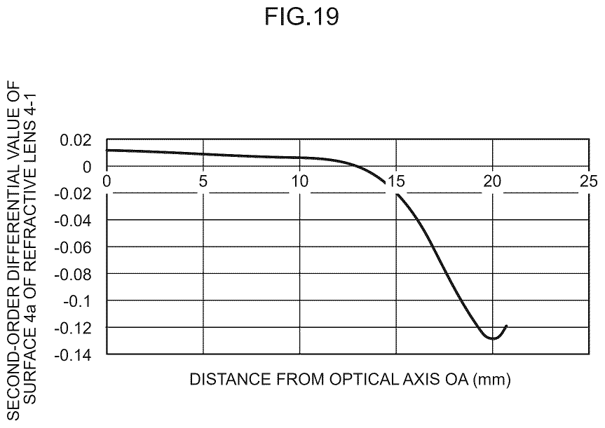

FIGS. 16 to 21 are diagrams illustrating a design example. Conditions that are not specifically described may be the same as those in the first embodiment described above. FIG. 16 illustrates examples of the MTF. It can be seen that high resolving power is obtained. For example, a center resolving power of about 50 PPD is obtained. FIG. 17 illustrates an example of the lateral chromatic aberration at the time of eyeball rotation. FIG. 18 exemplifies longitudinal aberration, astigmatism, and distortion. It can be seen that a practical lateral chromatic aberration is obtained. FIG. 19 illustrates an example of the inflection point of the surface 4a of the refractive lens 4-1. Aberration balance is maintained by the inflection point.

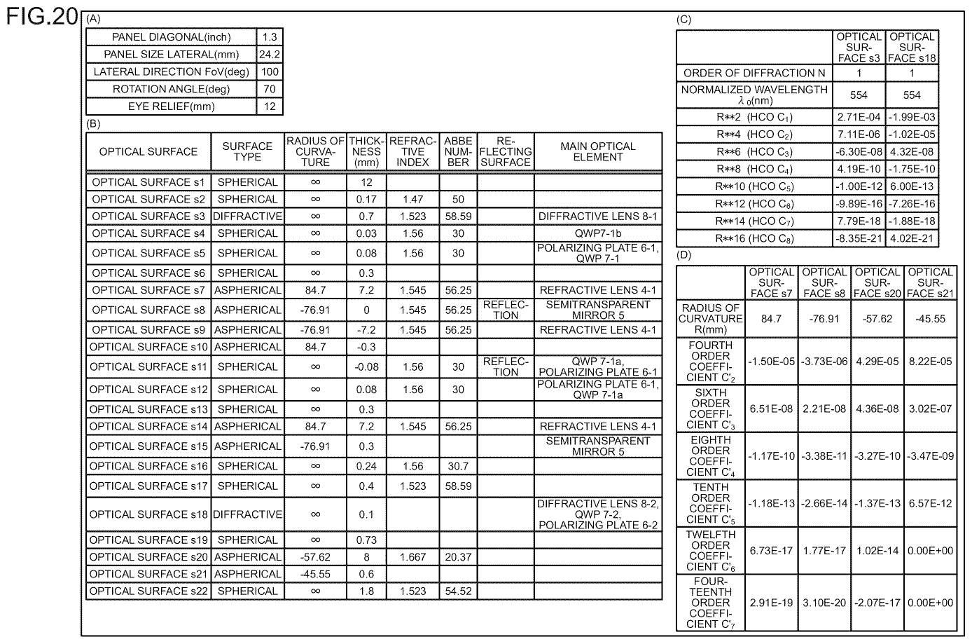

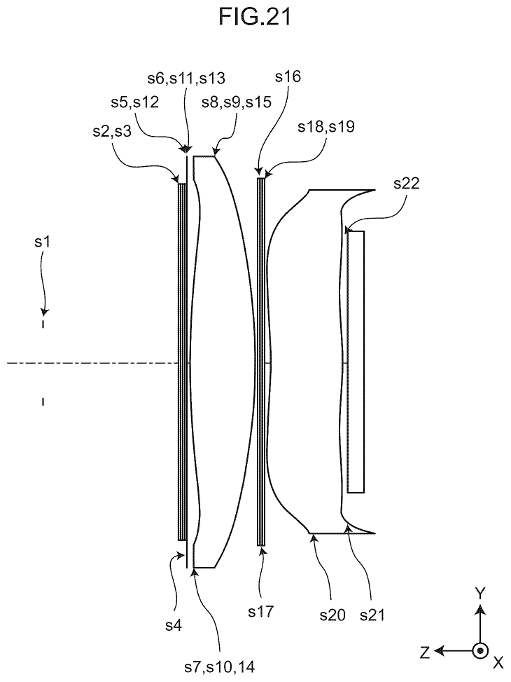

FIGS. 20 and 21 illustrate examples of data on some optical surfaces. FIG. 20 illustrates examples of data on the optical surface s1 to an optical surface s22. Specific locations of respective optical surfaces are as illustrated in FIG. 21. As indicated in (A) of FIG. 20, in this example, the diagonal length (panel diagonal) of the display panel 2 is 1.3 inches. The length (panel size lateral) of the panel of the display panel 2 in the lateral direction is 24.2 mm. The viewing angle in the lateral direction (lateral direction FoV) is 100°. The rotation angle is 70°. The eye relief is 12 mm. In (B) of FIG. 20, indicated are data on the optical surface s1 to the optical surface s22. In (C) of FIG. 20, indicated are further data on the optical surface s3 and the optical surface s18. The optical surface s3 and the optical surface s18 correspond to the surface of the diffractive lens 8-1 and the surface of the diffractive lens 8-2 described above, and each give a phase delay to light passing therethrough. The optical surface s18 also corresponds to the QWP 7-2 and the polarizing plate 6-2. The amount of phase delay φ is expressed by Formula (1) above, and numerical examples of cₙ (n=1 to 8) in Formula (1) are indicated in (C) of FIG. 20. In (D) of FIG. 20, indicated are further data on the optical surfaces whose surface type is aspherical. Specifically, indicated are coefficients that define amounts of aspherical sag of the optical surface s7, the optical surface s8, the optical surface s20, and the optical surface s21. The amount of aspherical sag is represented by Formula (2) above, and numerical examples of C′ₙ (n=2 to 7) therein are indicated in (D) of FIG. 20. Note that the total system focal length of the optical system 3 obtained by this design example is about 17.5 mm.

### Another Design Example

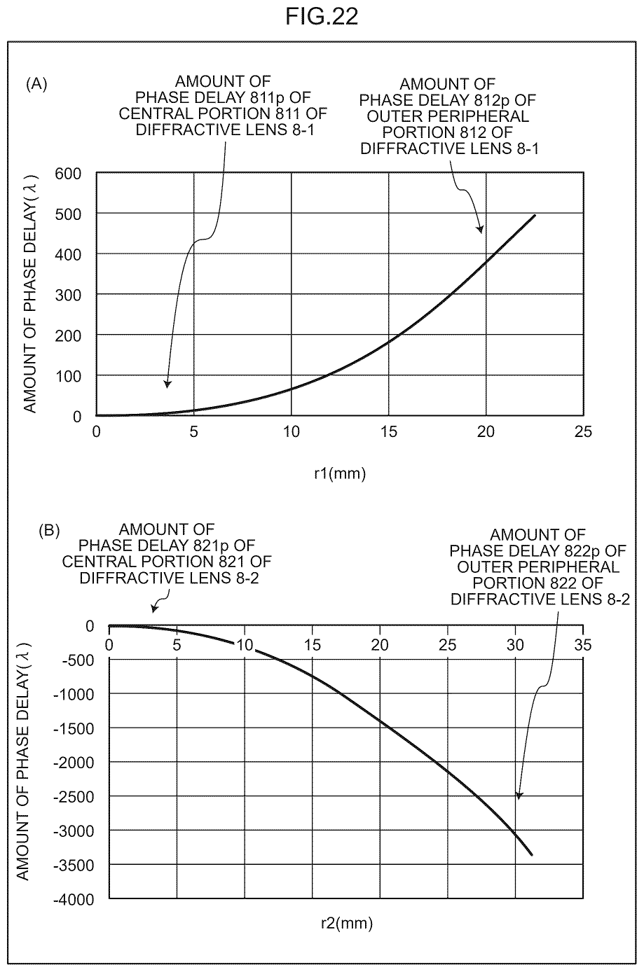

FIGS. 22 to 28 are diagrams illustrating another design example. It is possible to obtain a wider angle of view than the above design while minimizing a size enlargement of the display panel 2. FIG. 22 illustrates an example of an amount of optical phase delay given by the diffractive lens 8. In (A) of FIG. 22, the amount of phase delay given by the diffractive lens 8-1 is illustrated. In (B) of FIG. 22, the amount of phase delay given by the diffractive lens 8-2 is illustrated. Since the overall tendency is similar to that in FIG. 15 described above, the description thereof will be omitted.

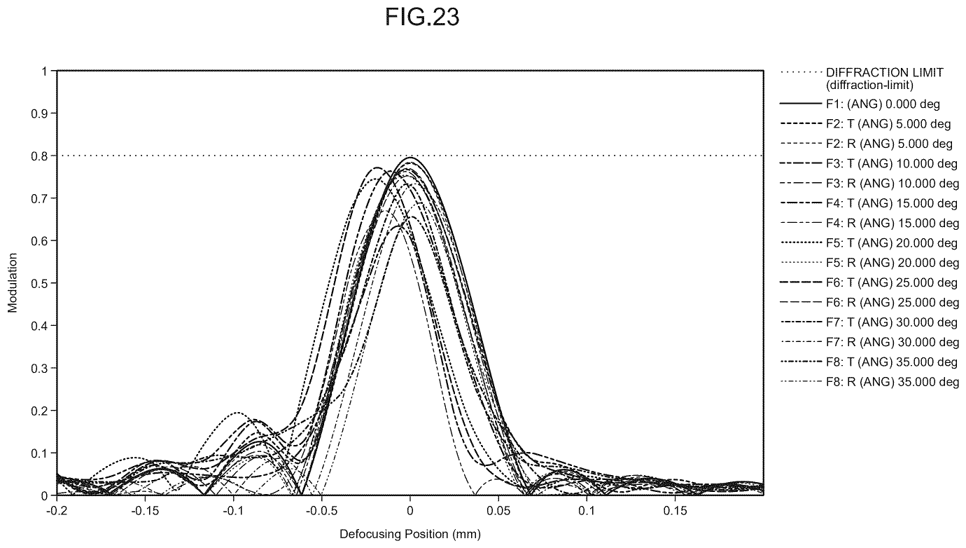

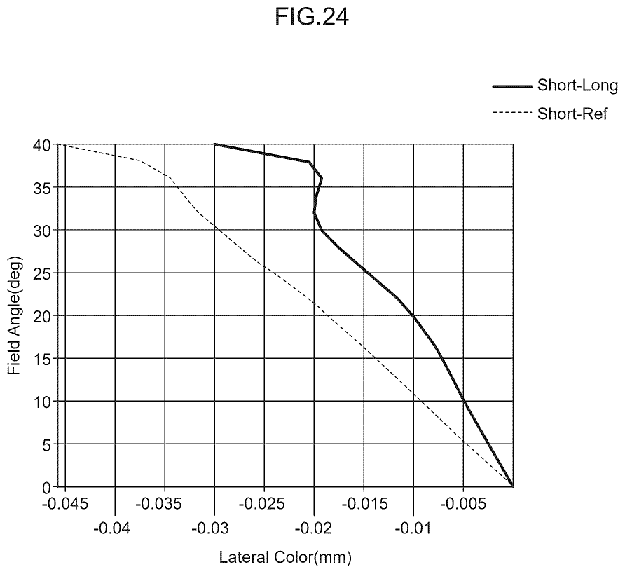

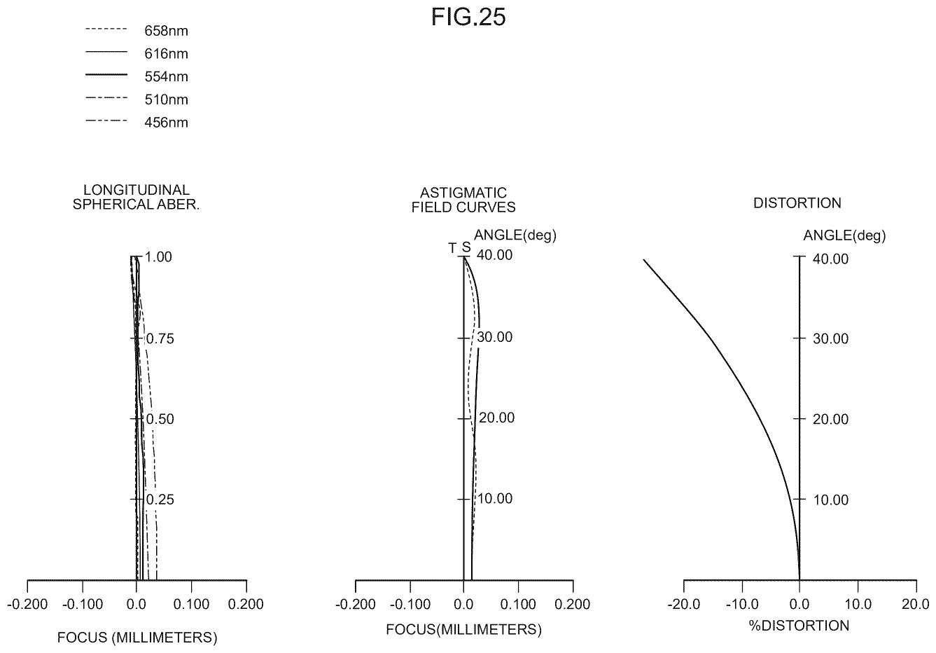

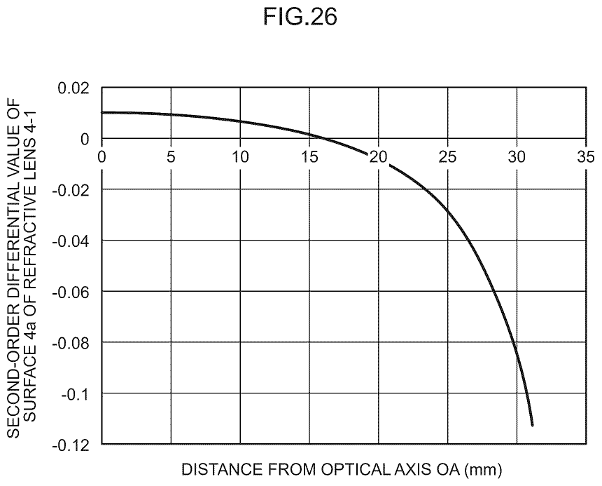

FIG. 23 illustrates examples of the MTF. It can be seen that high resolving power is obtained. For example, if the size of one pixel of the display device 1 is 6.3 μm, a center resolving power of about 77 PPD can be obtained. Even if the size of one pixel is 11 μm, a center resolving power of about 44 PPD can be obtained. FIG. 24 illustrates an example of the lateral chromatic aberration at the time of eyeball rotation. FIG. 25 exemplifies longitudinal aberration, astigmatism, and distortion. It can be seen that a practical lateral chromatic aberration is obtained. FIG. 26 illustrates an example of the inflection point of the surface 4a of the refractive lens 4-1. Aberration balance is maintained by the inflection point.

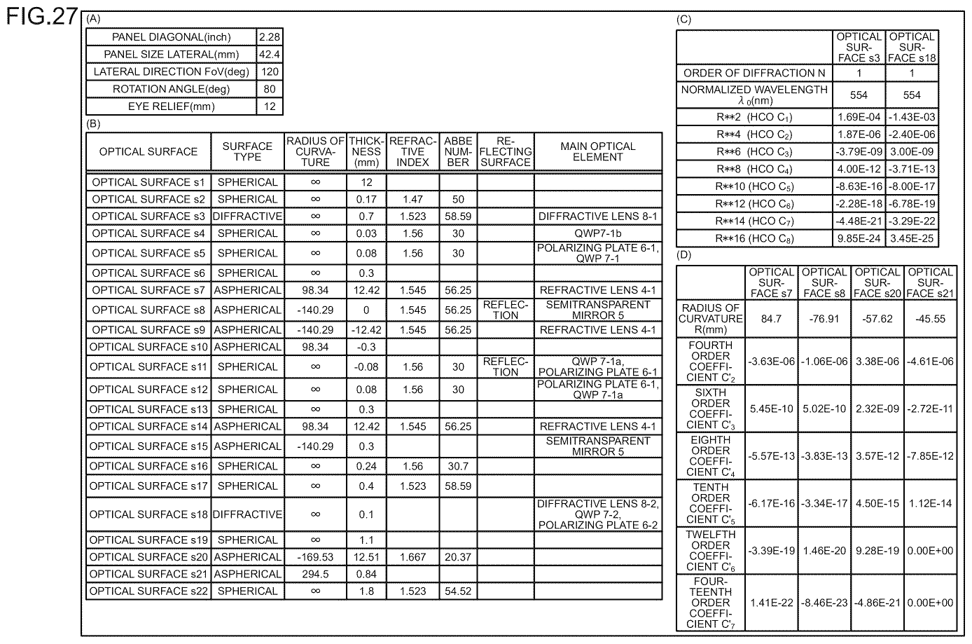

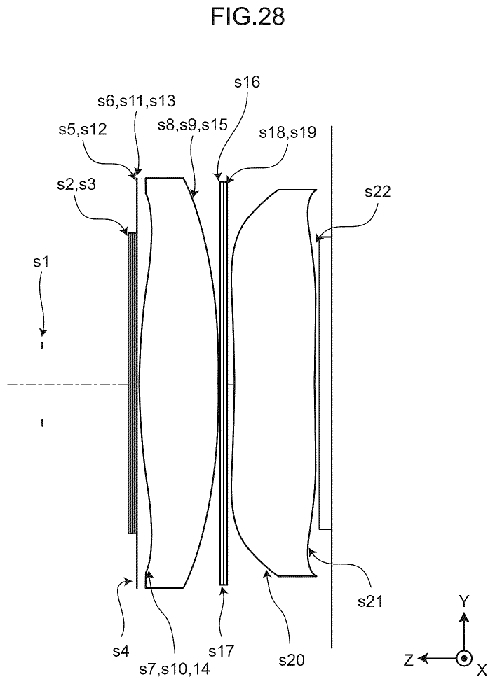

FIGS. 27 and 28 illustrate examples of data on some optical surfaces. FIG. 27 illustrates examples of data on the optical surface s1 to the optical surface s22. Specific locations of respective optical surfaces are as illustrated in FIG. 28. As indicated in (A) of FIG. 27, in this example, the diagonal length (panel diagonal) of the display panel 2 is 2.28 inches. The length (panel size lateral) of the panel of the display panel 2 in the lateral direction is 42.4 mm. The viewing angle in the lateral direction (lateral direction FoV) is 120°. The rotation angle is 80°. The eye relief is 12 mm. In (B) of FIG. 27, indicated are data on the optical surface s1 to the optical surface s22. In (C) of FIG. 27, indicated are further data on the optical surface s3 and the optical surface s18. In (D) of FIG. 27, indicated are further data on the optical surfaces whose surface type is aspherical, more specifically, the optical surface s7, the optical surface s8, the optical surface s20, and the optical surface s21. Note that the total system focal length of the optical system 3 obtained by this design example is about 28.0 mm.

### 3. Modifications

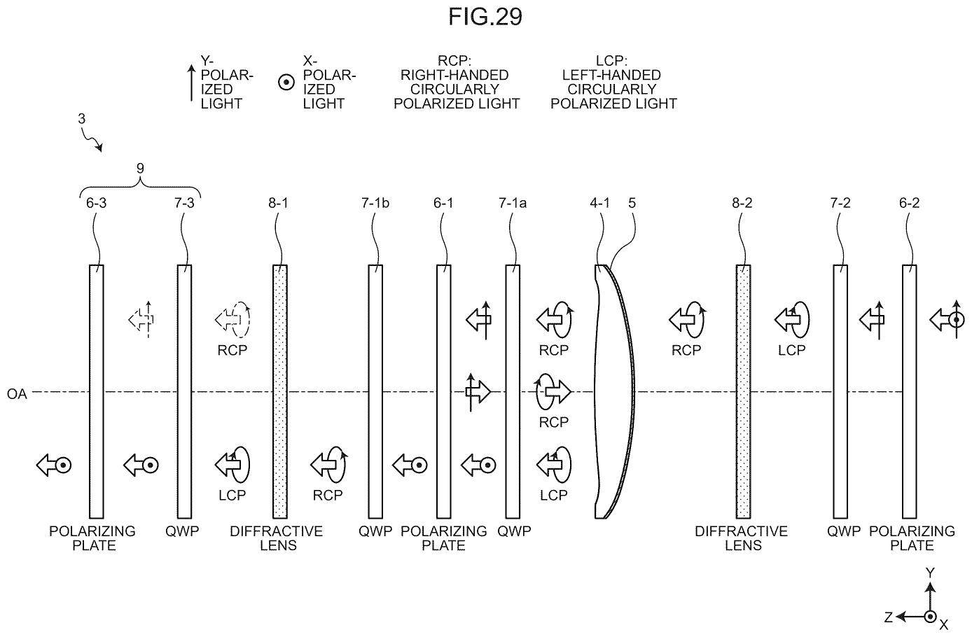

In one modification, the optical system 3 may include a cut filter that cuts unnecessary circularly polarized light. A description will be given with reference to FIGS. 29 to 32. Note that, in the following description, in a case where the diffractive lens 8-1 and the diffractive lens 8-2 are not particularly distinguished from each other, they are simply referred to as the diffractive lens 8.

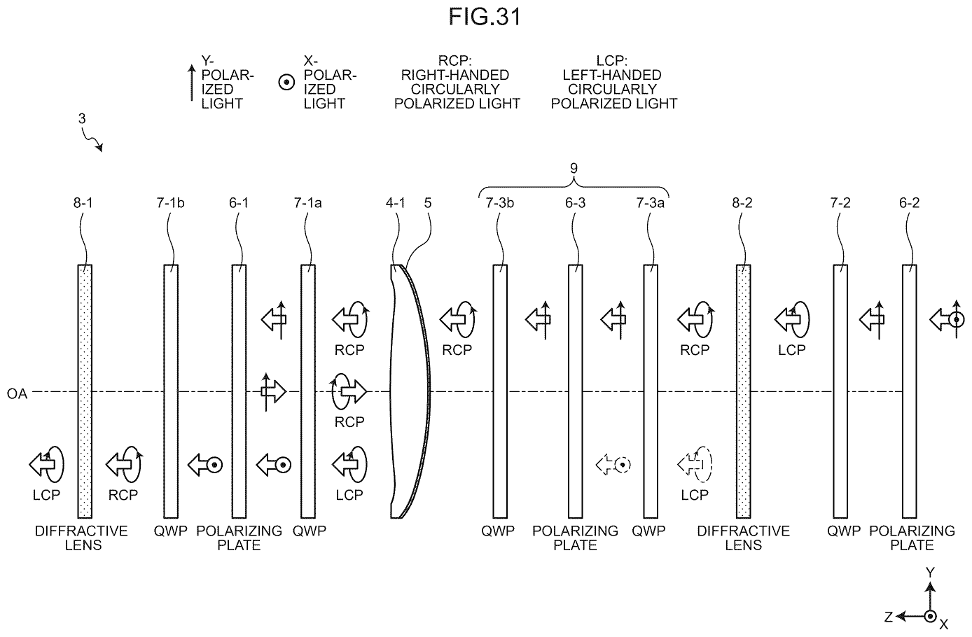

FIGS. 29 to 32 are diagrams illustrating modifications. As illustrated in FIGS. 29 and 31, the optical system 3 further includes a cut filter 9. The cut filter 9 cuts (removes or attenuates, for example) one type of circularly polarized light of two types of circularly polarized light that can be included in light from the diffractive lens 8. The cut filter 9 includes a QWP 7-3 and a polarizing plate 6-3.

In the example illustrated in FIG. 29, the cut filter 9 is provided at a subsequent stage of the diffractive lens 8-1, more specifically, between the diffractive lens 8-1 and the pupil position P (see FIG. 12 and the like) in this example. The QWP 7-3 and the polarizing plate 6-3 are disposed in this order in the Z-axis positive direction. The QWP 7-3 converts left-handed circularly polarized light into X-polarized light and converts right-handed polarized light into Y-polarized light. The polarizing plate 6-3 cuts (for example, reflects) Y-polarized light while allowing X-polarized light to pass therethrough.

The left-handed circularly polarized light from the diffractive lens 8-1 is converted into X-polarized light by the QWP 7-3, passes through the polarizing plate 6-3, and becomes substantially parallel light. Here, as virtually illustrated by a one-dot chain line, there is a possibility that right-handed circularly polarized light generated as stray light is slightly mixed in the light from the diffractive lens 8-1. The right-handed circularly polarized light is converted into Y-polarized light by the QWP 7-3 and cut by the polarizing plate 6-3.

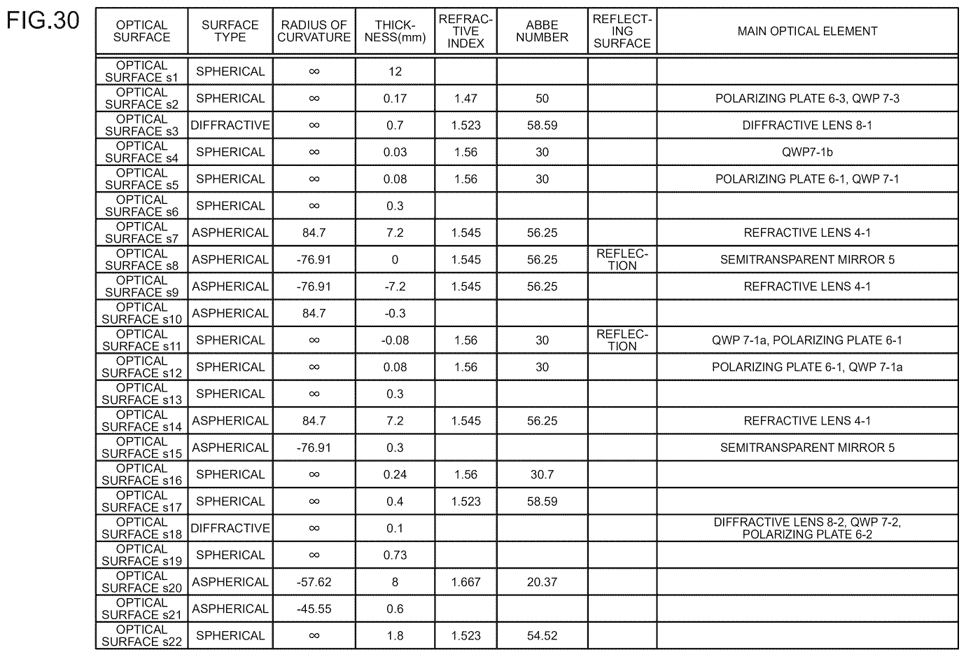

FIG. 30 illustrates examples of data on some optical surfaces in the configuration of FIG. 29 described above. Approximate locations of respective optical surfaces can be represented similarly to FIG. 21 described above, and thus, are not illustrated here.

In the example illustrated in FIG. 31, the cut filter 9 is provided at a subsequent stage of the diffractive lens 8-2, more specifically, between the diffractive lens 8-2 and the semitransparent mirror 5 in this example. The QWP 7-3 is a pair of QWPs, and the QWPs are respectively referred to as a QWP 7-3a and a QWP 7-3b and illustrated. The QWP 7-3a, the polarizing plate 6-3, and the QWP 7-3b are disposed in this order in the Z-axis positive direction.

In this example, the QWP 7-3a converts right-handed circularly polarized light into Y-polarized light and converts left-handed circularly polarized light into X-polarized light. The polarizing plate 6-3 cuts X-polarized light while allowing Y-polarized light to pass therethrough. The QWP 7-3b converts Y-polarized light into right-handed circularly polarized light.

The right-handed circularly polarized light from the diffractive lens 8-2 is converted into Y-polarized light by the QWP 7-3a, passes through the polarizing plate 6-3, is converted into right-handed circularly polarized light by the QWP 7-3b, and is incident on the semitransparent mirror 5. Here, as virtually illustrated by a one-dot chain line, there is a possibility that left-handed circularly polarized light generated as stray light is slightly mixed in the light from the diffractive lens 8-2. The left-handed circularly polarized light is converted into X-polarized light by the QWP 7-3a and cut by the polarizing plate 6-3.

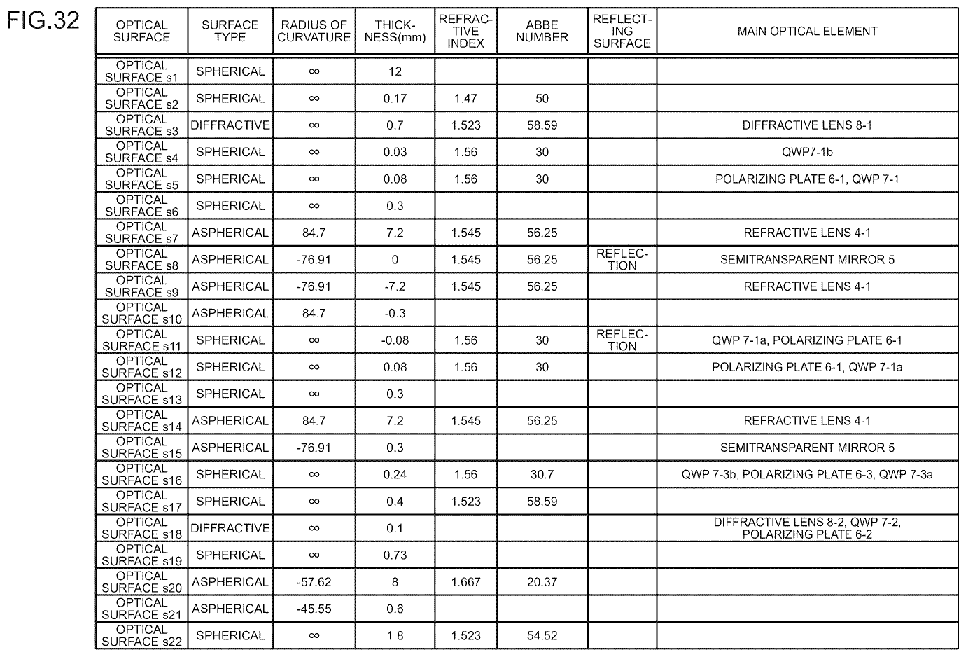

FIG. 32 illustrates examples of data on some optical surfaces in the configuration of FIG. 31 described above. Approximate locations of respective optical surfaces can be represented similarly to FIG. 21 described above, and thus, are not illustrated here.

For example, as described above, it is possible to cut unnecessary circularly polarized light out of the right-handed polarized light and the left-handed polarized light that can be included in the light from the diffractive lens 8. By removing unnecessary circularly polarized light, it is possible to suppress flare, for example.

### 4. Examples of Effects

The technology described above is specified as follows, for example. One of the disclosed technologies is the optical system 3. As described with reference to FIGS. 1 to 4, 12 to 15, 29, 31, and the like, the optical system 3 is an optical system that forms an image of light from the display panel 2 on the retina when combined with the eyeball, and includes the refractive lens 4-1 (first refractive lens) that collects the light from the display panel 2 and the diffractive lens 8-1 (first diffractive lens) provided between the refractive lens 4-1 and the pupil position P (eyeball). The diffractive lens 8-1 is configured such that a phase of light passing through the outer peripheral portion 812 is delayed from a phase of light passing through the central portion 811.

According to the optical system 3, since the optical system 3 includes not only the refractive lens 4-1 but also the diffractive lens 8-1, the lens function can be improved accordingly. As a result, a wide angle of view can be achieved.

As described with reference to FIGS. 1, 2, 12, 13, 29, 31, and the like, the optical system 3 may be configured such that the light from the display panel 2 passes through the refractive lens 4-1 three times by folding back the optical path. For example, in such a triple-pass-type optical system 3, a wide angle of view can be achieved.

As described with reference to FIGS. 12 to 15, 29, 31, and the like, the optical system 3 may include the diffractive lens 8-2 (second diffractive lens) provided between the display panel 2 and the refractive lens 4-1. The diffractive lens 8-2 may be configured such that a phase of light passing through the outer peripheral portion 822 advances more than a phase of light passing through the central portion 821. By providing such a diffractive lens 8-2, it is possible to prevent the light from spreading too much and the lens from being large. A possibility of achieving a wider angle of view is increased.

As described with reference to FIGS. 3, 14, 15, and the like, the diffractive lens 8-1 may give a positive phase delay (amount of phase delay 821p) to the light passing through the outer peripheral portion 812, and the diffractive lens 8-2 may give a negative phase delay (amount of phase delay 822p) to the light passing through the outer peripheral portion 822. As a result, the lateral chromatic aberration generated in one diffractive lens of the diffractive lens 8-1 and the diffractive lens 8-2 can be canceled by the other diffractive lens, and the lateral chromatic aberration can be suppressed. Furthermore, field curvature and astigmatism can be reduced by a balance between the two. A high aberration correction effect can be obtained, and a wider angle of view can be achieved.

As described with reference to FIGS. 1, 2, 12, 13, 29, 31, and the like, the optical system 3 may include the refractive lens 4-2 (second refractive lens) provided between the display panel 2 and the diffractive lens 8-2. The refractive lens 4-2 may be configured to bring the light from the display panel 2 close to the optical axis direction (the direction of the optical axis OA) of the optical system 3. As a result, it is possible to maintain aberration balance, and furthermore, a balance between field curvature and distortion.

As described with reference to FIGS. 1, 9, 19, 26, and the like, the surface 4a of the refractive lens 4-1 on the pupil position P side (eyeball side) may have an inflection point. As a result, aberration balance can be maintained.

As described with reference to FIGS. 1, 2, 12, 13, 29, 31, and the like, the diffractive lens 8 (diffractive lens 8-1, diffractive lens 8-2) may be a polarization diffractive lens. As a result, it is easy to cope with oblique incidence and wavelength variation.

As described with reference to FIGS. 29, 31, and the like, the optical system 3 may include the cut filter 9 that cuts one type of circularly polarized light of two types of circularly polarized light (right-handed circularly polarized light and left-handed circularly polarized light) that can be included in the light from the diffractive lens 8 (diffractive lens 8-1, diffractive lens 8-2). By removing unnecessary circularly polarized light, it is possible to suppress flare, for example.

As described with reference to FIGS. 1, 2, 12, 13, and the like, the diffractive lens 8 (diffractive lens 8-1, diffractive lens 8-2) may have a thickness smaller than the thickness of the refractive lens 4. It is possible to contribute to making the optical system 3 thinner and smaller.

The display device 1 described with reference to FIGS. 1 to 4, 12 to 15, 29, 31, and the like is also one of the disclosed technologies. The display device 1 includes the display panel 2 and the optical system 3 that forms an image of light from the display panel 2 on a retina when combined with an eyeball. For example, the display device 1 may be an HMD device. Also in such a display device 1, as described above, a wide angle of view can be achieved.

The effects described in the present disclosure are merely examples and are not limited to the disclosed contents. There may be other effects.

Note that, the present technology can also have the following configurations.

(1) An optical system that forms an image of light from a display panel on a retina when combined with an eyeball, the optical system comprising:
a first refractive lens that collects the light from the display panel; and
a first diffractive lens provided between the first refractive lens and the eyeball, wherein
the first diffractive lens is configured such that a phase of light passing through an outer peripheral portion of the first diffractive lens is delayed from a phase of light passing through a central portion of the first diffractive lens.

(2) The optical system according to (1), wherein
the light from the display panel passes through the first refractive lens three times by folding back an optical path.

(3) The optical system according to (1) or (2), comprising
a second diffractive lens provided between the display panel and the first refractive lens.

(4) The optical system according to (3), wherein
the second diffractive lens is configured such that a phase of light passing through an outer peripheral portion of the second diffractive lens advances more than a phase of light passing through a central portion of the second diffractive lens.

(5) The optical system according to (4), wherein
the first diffractive lens gives a positive phase delay to the light passing through the outer peripheral portion of the first diffractive lens, and
the second diffractive lens gives a negative phase delay to the light passing through the outer periphery of the second diffractive lens.

(6) The optical system according to any one of (3) to (5), comprising
a second refractive lens provided between the display panel and the second diffractive lens.

(7) The optical system according to (6), wherein
the second refractive lens is configured to bring the light from the display panel close to an optical axis direction of the optical system.

(8) The optical system according to (6) or (7), wherein
a surface of the first refractive lens on the eyeball's side has an inflection point.

(9) The optical system according to any one of (1) to (8), wherein
the diffractive lens is a polarization diffractive lens.

(10) The optical system according to (9), comprising
a cut filter that cuts one type of circularly polarized light of two types of circularly polarized light having a possibility of being included in light from the diffractive lens.

(11) The optical system according to any one of (1) to (10), wherein
the diffractive lens has a thickness smaller than a thickness of the refractive lens.

(12) A display device comprising:
a display panel; and
an optical system that forms an image of light from the display panel on a retina when combined with an eyeball, wherein
the optical system includes:
a first refractive lens that collects the light from the display panel; and
a first diffractive lens provided between the first refractive lens and the eyeball, and
the first diffractive lens is configured such that a phase of light passing through an outer peripheral portion of the first diffractive lens is delayed from a phase of light passing through a central portion of the first diffractive lens.

(13) The display device according to (12), wherein
the display device includes a head mounted display device.

### REFERENCE SIGNS LIST

1 DISPLAY DEVICE
2 DISPLAY PANEL
2a DISPLAY SURFACE
3 OPTICAL SYSTEM
4 REFRACTIVE LENS
4-1 REFRACTIVE LENS
4-2 REFRACTIVE LENS
4a SURFACE
5 SEMITRANSPARENT MIRROR
6 POLARIZING PLATE
6-1 POLARIZING PLATE
6-2 POLARIZING PLATE
6-3 POLARIZING PLATE
7 QWP
7-1 QWP
7-1a QWP
7-1b QWP
7-2 QWP
7-3 QWP
7-3a QWP
7-3b QWP
8 DIFFRACTIVE LENS
8-1 DIFFRACTIVE LENS
811 CENTRAL PORTION
812 OUTER PERIPHERAL PORTION
8-2 DIFFRACTIVE LENS
821 CENTRAL PORTION
822 OUTER PERIPHERAL PORTION
9 CUT FILTER
OA OPTICAL AXIS
P PUPIL POSITION
U USER

What is claimed is:

1. An optical system that forms an image of light from a display panel on a retina when combined with an eyeball, the optical system comprising:
a first refractive lens that collects the light from the display panel; and
a first diffractive lens provided between the first refractive lens and the eyeball, wherein
the first diffractive lens is configured such that a phase of light passing through an outer peripheral portion of the first diffractive lens is delayed from a phase of light passing through a central portion of the first diffractive lens.

2. The optical system according to claim 1, wherein
the light from the display panel passes through the first refractive lens three times by folding back an optical path.

3. The optical system according to claim 1, comprising
a second diffractive lens provided between the display panel and the first refractive lens.

4. The optical system according to claim 3, wherein
the second diffractive lens is configured such that a phase of light passing through an outer peripheral portion of the second diffractive lens advances more than a phase of light passing through a central portion of the second diffractive lens.

5. The optical system according to claim 4, wherein
the first diffractive lens gives a positive phase delay to the light passing through the outer peripheral portion of the first diffractive lens, and
the second diffractive lens gives a negative phase delay to the light passing through the outer periphery of the second diffractive lens.

6. The optical system according to claim 3, comprising
a second refractive lens provided between the display panel and the second diffractive lens.

7. The optical system according to claim 6, wherein
the second refractive lens is configured to bring the light from the display panel close to an optical axis direction of the optical system.

8. The optical system according to claim 6, wherein
a surface of the first refractive lens on the eyeball's side has an inflection point.

9. The optical system according to claim 1, wherein
the diffractive lens is a polarization diffractive lens.

10. The optical system according to claim 9, comprising
a cut filter that cuts one type of circularly polarized light of two types of circularly polarized light having a possibility of being included in light from the diffractive lens.

11. The optical system according to claim 1, wherein
the diffractive lens has a thickness smaller than a thickness of the refractive lens.

12. A display device, comprising:
a display panel; and
an optical system that forms an image of light from the display panel on a retina when combined with an eyeball, wherein
the optical system includes:
a first refractive lens that collects the light from the display panel; and
a first diffractive lens provided between the first refractive lens and the eyeball, and
the first diffractive lens is configured such that a phase of light passing through an outer peripheral portion of the first diffractive lens is delayed from a phase of light passing through a central portion of the first diffractive lens.

13. The display device according to claim 12, wherein
the display device includes a head mounted display device.
